(19) United States
(12) Patent Application Publication
(10) Pub. No.: US 2025/0333569 A1
(43) Pub. Date: Oct. 30, 2025

(54) POLYMER POWDER, PRODUCTION METHOD OF POLYMER POWDER, POLYMER COMPOSITION, AND POLYMER FILM

(71) Applicant: FUJIFILM Corporation, Tokyo (JP)

(72) Inventors: Yasuyuki Sasada, Kanagawa (JP); Shohei Yamazaki, Kanagawa (JP); Miyoko Shibano, Kanagawa (JP); Misato Sasada, Kanagawa (JP)

(73) Assignee: FUJIFILM Corporation, Tokyo (JP)

(21) Appl. No.: 19/258,846

(22) Filed: Jul. 2, 2025

Related U.S. Application Data
(63) Continuation of application No. PCT/JP2023/042083, filed on Nov. 22, 2023.

(30) Foreign Application Priority Data
Jan. 10, 2023 (JP) 2023-001988

(51) Int. Cl. C08J 7/02; B29B 9/02; B29B 9/12; B29K 25/00; C08J 3/12; C08J 5/18

(52) U.S. Cl. CPC C08J 7/02; B29B 9/02; B29B 9/12; C08J 3/12; C08J 5/18; B29K 2025/08; C08J 2353/00; C08J 2353/02

(57) ABSTRACT

A production method of a polymer powder, including a step of swelling a polymer having a weight-average molecular weight of 1,000 or more in a liquid medium, and a step of pulverizing the swollen polymer to obtain a polymer powder.

### CROSS-REFERENCE TO RELATED APPLICATION

This application is a Continuation of International Application No. PCT/JP2023/042083, filed Nov. 22, 2023, which claims priority to Japanese Patent Application No. 2023-001988 filed Jan. 10, 2023. Each of the above applications is hereby expressly incorporated by reference, in its entirety, into the present application.

### BACKGROUND OF THE INVENTION

### 1. Field of the Invention

The present disclosure relates to a polymer powder, a production method of a polymer powder, a polymer composition, and a polymer film.

### 2. Description of the Related Art

In the related art, various methods for pulverizing polymers into powder form have been studied.

For example, JP1999-209478A (JP-H11-209478A) describes a production method of elastomer particles, which is characterized in that in a method of forming fine particles of an elastomer by a spray-drying method, fine particles insoluble in a solvent of the elastomer are present in a solution of the elastomer and the solution is spray-dried.

WO2016/031845A describes a production method of elastomer particles, including a step of dissolving an elastomer having a glass transition point of −100° C. to 0° C. in a poorly water-soluble organic solvent to obtain an elastomer solution, a step of adding the elastomer solution to water or a water-soluble medium having a specific gravity of 1 or less to disperse the elastomer as fine liquid droplets in water or the water-soluble medium having a specific gravity of 1 or less to obtain a dispersion liquid, and a step of pressurizing the dispersion liquid and then depressurizing the dispersion liquid to generate void nuclei in the fine liquid droplets.

### SUMMARY OF THE INVENTION

In the production method of a polymer powder, it is required to further reduce the particle diameter of the obtained polymer powder and to reduce the number of coarse particles.

An object to be achieved by an embodiment of the present invention is to provide a polymer powder and a production method of a polymer powder, in which the particle diameter is smaller and the number of coarse particles is small as compared with the related art.

An object to be achieved by another embodiment of the present invention is to provide a polymer composition and a polymer film, which contain the above-described polymer powder.

The methods for achieving the above-described objects include the following aspects.

<1>

A production method of a polymer powder, including:
a step of swelling a polymer having a weight-average molecular weight of 1,000 or more in a liquid medium; and
a step of pulverizing the swollen polymer to obtain a polymer powder.
   <2>

The production method of a polymer powder according to <1>, in which the polymer having a weight-average molecular weight of 1,000 or more has a storage elastic modulus of less than 1 GPa.

<3>

The production method of a polymer powder according to <1> or <2>, in which the polymer having a weight-average molecular weight of 1,000 or more is a thermoplastic elastomer.

<4>

The production method of a polymer powder according to <3>, in which the thermoplastic elastomer is an elastomer containing a constitutional unit derived from styrene.

<5>

The production method of a polymer powder according to <3>, in which the thermoplastic elastomer is at least one selected from the group consisting of a styrene-ethylene-butylene-styrene block copolymer, a styrene-isobutylene-styrene block copolymer, a styrene-ethylene-propylene-styrene copolymer, a styrene-isoprene-styrene block copolymer, and hydrogenated products thereof.

<6>

The production method of a polymer powder according to any one of <1> to <5>, in which the swollen polymer has a swelling degree of 1% to 1,000%.

<7>

The production method of a polymer powder according to any one of <1> to <6>, in which an absolute value of a difference between a solubility parameter of the liquid medium and a solubility parameter of the polymer having a weight-average molecular weight of 1,000 or more is from 5 MPa^{1/2} to 10 MPa^{1/2}.

<8>

The production method of a polymer powder according to any one of <1> to <7>, in which the swollen polymer is cooled in a temperature environment of −50° C. or lower, and then pulverized.

<9>

A polymer powder which is a pulverized product of a polymer swollen in a liquid medium.

<10>

A polymer powder including:
a polymer having an average particle diameter D50 of 15 μm or less, a proportion of coarse particles having a particle diameter of 20 μm or more of 20% by mass or less, and a storage elastic modulus of less than 1 GPa.
   <11>

A polymer powder including:
a thermoplastic elastomer having an average particle diameter D50 of 15 μm or less and a proportion of coarse particles having a particle diameter of 20 μm or more of 20% by mass or less.
   <12>

A polymer composition including the polymer powder according to any one of <9> to <11>.

<13>

The polymer composition according to <12>, further including a polymer having a dielectric loss tangent of 0.01 or less.

<14>

A polymer film including the polymer powder according to any one of <9> to <11>.

According to one embodiment of the present invention, there are provided a polymer powder and a production method of a polymer powder, in which the polymer powder has a smaller particle diameter and fewer coarse particles as compared with those of the related art.

According to another embodiment of the present invention, a polymer composition and a polymer film, which contain the above-described polymer powder, are provided.

### DESCRIPTION OF THE PREFERRED EMBODIMENTS

Hereinafter, the contents of the present disclosure will be described in detail. The description of configuration requirements below is made based on representative embodiments of the present disclosure in some cases, but the present disclosure is not limited to such embodiments.

In the present specification, a numerical range shown using “to” indicates a range including numerical values described before and after “to” as a lower limit value and an upper limit value.

In a numerical range described in a stepwise manner in the present disclosure, an upper limit value or a lower limit value described in one numerical range may be replaced with an upper limit value or a lower limit value in another numerical range described in a stepwise manner. In addition, in a numerical range described in the present disclosure, an upper limit value or a lower limit value described in the numerical range may be replaced with a value described in an example.

In addition, in a case where substitution or unsubstitution is not noted in regard to the notation of a “group” (atomic group) in the present specification, the “group” includes not only a group that does not have a substituent but also a group having a substituent. For example, the concept of an “alkyl group” includes not only an alkyl group that does not have a substituent (unsubstituted alkyl group) but also an alkyl group having a substituent (substituted alkyl group).

In the present specification, the concept of “(meth)acryl” includes both acryl and methacryl, and the concept of “(meth)acryloyl” includes both acryloyl and methacryloyl.

Further, the term “step” in the present specification indicates not only an independent step but also a step which cannot be clearly distinguished from other steps as long as the intended purpose of the step is achieved.

Furthermore, in the present disclosure, a combination of two or more preferred embodiments is a more preferred embodiment.

In addition, the weight-average molecular weight (Mw) and the number-average molecular weight (Mn) in the present disclosure are molecular weights converted using polystyrene as a standard substance by performing detection with a gel permeation chromatography (GPC) analysis apparatus using TSKgel SuperHM-H (trade name, manufactured by Tosoh Corporation) column, a solvent of pentafluorophenol (PFP) and chloroform at a mass ratio of 1:2, and a differential refractometer, unless otherwise specified.

### [Production Method of Polymer Powder]

The production method of a polymer powder according to the present disclosure includes a step of swelling a polymer having a weight-average molecular weight of 1,000 or more in a liquid medium (hereinafter, also referred to as a “swelling step”) and a step of pulverizing the swollen polymer to obtain a polymer powder (hereinafter, also referred to as a “pulverizing step”).

According to the production method of a polymer powder according to the present disclosure, it is possible to obtain polymer particles having a small particle diameter and few coarse particles.

The detailed mechanism that brings about the aforementioned effect is unclear, but is assumed to be as below.

It is considered that, by pulverizing the swollen polymer, the particles are unlikely to reaggregate after the pulverization.

In addition, in the related art, powdering of a polymer having a relatively high storage elastic modulus by a mechanical pulverization method is known. On the other hand, in a polymer having a relatively low storage elastic modulus, the pulverization energy applied to the polymer may not be sufficiently transmitted due to deformation of the polymer or may be lost due to viscosity, and thus the polymer may not be sufficiently pulverized. In addition, in a polymer having a relatively low storage elastic modulus, the surface energy of the pulverized polymer is high, and in a case where particles are brought close to each other, the particles may aggregate or the surface of the particles may melt due to heat generated during pulverization and may be re-fused. Therefore, it is difficult to obtain polymer particles having a small particle diameter and few coarse particles in a polymer having a relatively low elastic modulus. According to the production method of a polymer powder according to the present disclosure, even in a case of a polymer having a relatively low storage elastic modulus, polymer particles having a small particle diameter and few coarse particles can be obtained.

On the other hand, JP1999-209478A (JP-H11-209478A) and WO2016/031845A do not disclose that the polymer is swollen in advance before pulverization.

### (Swelling Step)

The production method of a polymer powder according to the present disclosure includes a step of swelling a polymer having a weight-average molecular weight of 1000 or more in a liquid medium.

### —Polymer Having Weight-Average Molecular Weight of 1000 or More—

The kind of the polymer having a weight-average molecular weight of 1,000 or more, which is used in the swelling step, is not particularly limited. Hereinafter, the polymer having a weight-average molecular weight of 1000 or more, which is used in the swelling step, is also referred to as a “specific polymer”. The specific polymer may be used alone or in combination of two or more kinds thereof.

The specific polymer may be a thermosetting resin, a thermoplastic resin, a thermosetting elastomer, or a thermoplastic elastomer.

The elastomer is a polymer that exhibits rubber elasticity at normal temperature. As the molecular structure, the thermosetting elastomer is a vulcanized (crosslinked) polymer, and examples of the crosslinking agent include a peroxide vulcanization-based crosslinking agent, a sulfur vulcanization-based crosslinking agent, an amine vulcanization-based crosslinking agent, a UV-based vulcanization-based crosslinking agent, a polyvalent epoxy vulcanization-based crosslinking agent, a polyvalent isocyanate vulcanization-based crosslinking agent, an aziridine vulcanization-based crosslinking agent, a basic metal oxide vulcanization-based crosslinking agent, and an organic metal halide vulcanization-based crosslinking agent. Specific examples of the thermosetting elastomer include nitrile butadiene rubber (NBR), hydrogenated nitrile rubber (HNBR), ethylene propylene diene rubber (EPDM), isobutylene isoprene rubber (IIR: butyl rubber), silicone rubber, fluorine rubber, and acrylic rubber. The thermoplastic elastomer is distinguished from a resin in that the thermoplastic elastomer has a soft segment such as a polyether or a rubber molecule and a hard segment such as a vulcanized rubber that prevents plastic deformation at around room temperature.

Examples of the thermosetting resin include an epoxy resin, a phenol resin, an unsaturated imide resin, a cyanate resin, an isocyanate resin, a benzoxazine resin, an oxetane resin, an amino resin, an unsaturated polyester resin, an allyl resin, a dicyclopentadiene resin, a silicone resin, a triazine resin, a melamine resin, and the like.

Examples of the thermoplastic resin include an acrylic resin, polyacetal, polyamide, polyethylene, polypropylene, polyethylene terephthalate, polybutylene terephthalate, polycarbonate, polystyrene, polyphenylene sulfide, polyvinyl chloride, an ABS resin (acrylonitrile-butadiene-styrene copolymer), and an AS resin (acrylonitrile-styrene copolymer).

Examples of the thermoplastic elastomer include an elastomer (polystyrene-based elastomer) containing a constitutional unit derived from styrene, a polyester-based elastomer, a polyolefin-based elastomer, a polyurethane-based elastomer, a polyamide-based elastomer, a polyacryl-based elastomer, a silicone-based elastomer, and a polyimide-based elastomer. The thermoplastic elastomer may be a hydrogenated product.

Examples of the polystyrene-based elastomer include a styrene-butadiene-styrene block copolymer (SBS), a styrene-isoprene-styrene block copolymer (SIS), a styrene-ethylene-propylene block copolymer (SEP), a styrene-ethylene-propylene-styrene block copolymer (SEPS), a styrene-ethylene-butylene-styrene block copolymer (SEBS), a styrene-ethylene-ethylene-propylene-styrene block copolymer (SEEPS), a styrene-isobutylene-styrene block copolymer (SIBS), and hydrogenated products thereof.

In general, it is difficult to reduce the particle diameter of the thermoplastic elastomer, but according to the production method of a polymer powder according to the present disclosure, it is possible to obtain a thermoplastic elastomer powder having a smaller particle diameter and fewer coarse particles than those of the related art.

The specific polymer is preferably a thermoplastic elastomer or a thermosetting elastomer, and more preferably a thermoplastic elastomer.

Among these, the thermoplastic elastomer is preferably an elastomer containing a constitutional unit derived from styrene or an elastomer containing a constitutional unit derived from an olefin, more preferably an elastomer containing a constitutional unit derived from styrene, and still more preferably at least one selected from the group consisting of a styrene-ethylene-butylene-styrene block copolymer, a styrene-isobutylene-styrene block copolymer, a styrene-ethylene-propylene-styrene copolymer, a styrene-isoprene-styrene block copolymer, and hydrogenated products thereof.

The weight-average molecular weight of the specific polymer is not particularly limited as long as it is 1,000 or more, and is preferably 10,000 or more and more preferably 30,000 or more. The upper limit value of the weight-average molecular weight is, for example, 1,000,000.

The specific polymer preferably has a storage elastic modulus of less than 1 GPa, more preferably 0.5 GPa or less, and still more preferably 0.1 GPa or less. The lower limit value of the storage elastic modulus is not particularly limited, and is, for example, 0.0001 GPa. The elastic modulus of the specific polymer is measured by the following method.

The indentation elastic modulus can be measured by cutting out pellets or lumps of the polymer to an appropriate size and using a nanoindentation method. The indentation elastic modulus is measured by using a microhardness meter (product name “DUH-W201”, manufactured by Shimadzu Corporation) to apply a load at a loading rate of 0.28 mN/sec with a Vickers indenter at room temperature (25° C.), holding a maximum load of 10 mN for 10 seconds, and then unloading at a loading rate of 0.28 mN/sec.

Examples of the polymer having a storage elastic modulus of less than 1 GPa include a thermoplastic elastomer and a fluororesin.

### —Liquid Medium—

The liquid medium used in the swelling step is not particularly limited as long as it is a compound that is in a liquid state at 25° C. In addition, in a case where the swelling step is performed in a heated state, a compound that is in a liquid state at a heated temperature can be used. Examples of the liquid medium include water and an organic solvent. The liquid medium may be used alone or in combination of two or more kinds thereof.

Examples of the organic solvent include alcohol, ketone, alkyl halide, amide, sulfoxides, heterocyclic compounds, hydrocarbons, ester, and ether.

Among these, from the viewpoint of swelling the specific polymer in a liquid medium, the absolute value of the difference between the solubility parameter of the liquid medium and the solubility parameter of the polymer having a weight-average molecular weight of 1,000 or more is preferably from 5 MPa^{1/2} to 10 MPa^{1/2} and more preferably from 6 MPa^{1/2} to 8 MPa^{1/2}.

In a case where the number of liquid media is two or more, the solubility parameter of the liquid medium is a weighted average value.

In the present disclosure, a Hansen solubility parameter is used as the solubility parameter.

The Hansen solubility parameter is obtained by dividing the solubility parameter introduced by Hildebrand into three components of a dispersion element δd, a polarity element Sp, and a hydrogen bond element δh, and expressing the components in a three-dimensional space. In the present disclosure, the solubility parameter is represented by δ (unit: MPa^{1/2}), and a value calculated using the following expression is used.

δ(MPa)^{1/2}=(δd²+δp²+δh²)^{1/2}

The dispersion element δd, the polarity element δp, and the hydrogen bond element δh of various substances have been found by Hansen and his successors, and are described in detail in the Polymer Handbook (fourth edition), VII-698 to 711. The values of Hansen solubility parameters are also specifically described in the document “Hansen Solubility Parameters; A Users Handbook (CRC Press, 2007)” written by Charles M. Hansen.

The solubility parameter of the polymer can be calculated by the Hoy method described in Polymer Handbook (fourth edition) from the molecular structure of the polymer.

In the swelling step, from the viewpoint of further reducing the particle diameter by pulverization, the swelling degree of the swollen polymer is preferably from 1% to 1000%, more preferably from 50% to 500%, and still more preferably from 100% to 250%.

In the present disclosure, the swelling degree is calculated by the following method.

After swelling the polymer in a liquid medium, about 1 g of a measurement sample is collected from the swollen polymer, and the measurement sample is weighed. The weighed mass is denoted by W1 (g). The measurement sample is dried for 3 hours, and the dried measurement sample is weighed. The weighed mass is denoted by W0 (g). The swelling degree is calculated from the following expression. The drying temperature in a case of drying the measurement sample is set to a higher temperature between a boiling point of the liquid medium used for swelling the polymer and a glass transition temperature of the polymer.

Swelling degree (%)={(W1−W0)/W0}×100

In a case where the polymer is swollen in a liquid medium, the temperature of the liquid medium is not particularly limited as long as the liquid medium is in a liquid state, and for example, it is preferably from 10° C. to 60° C. In addition, the step of swelling the polymer in a liquid medium may be carried out under pressure. In a case of pressurization, the pressure is not particularly limited, and for example, it is preferably from 0.101 MPa to 10 MPa.

### (Pulverizing Step)

The production method of a polymer powder according to the present disclosure includes a step of pulverizing a swollen polymer to obtain a polymer powder.

The means for pulverizing the swollen polymer is not particularly limited, and examples thereof include a combination of a mortar and a pestle, and a pulverizer (for example, a ball mill, a beads mill, a roller mill, a jet mill, a hammer mill, or an attritor).

The swollen specific polymer may be pulverized while maintaining the temperature at room temperature, but from the viewpoint of further reducing the particle diameter of the obtained polymer powder, it is preferable that the swollen polymer is cooled in a temperature environment of −50° C. or lower, and then pulverized.

The temperature at which the swollen polymer is cooled is preferably a temperature lower than the melting point of the liquid medium, and more preferably a temperature lower than the melting point of the liquid medium by 10° C. or more. Specifically, the temperature for cooling the swollen polymer is more preferably −80° C. or lower and still more preferably −100° C. or lower.

### [Polymer Powder]

A first aspect of the present disclosure relates to a polymer powder which is a pulverized product of a polymer swollen in a liquid medium.

A second aspect of the polymer powder according to the present disclosure contains a polymer having an average particle diameter D50 of 15 μm or less and an elastic modulus of less than 1 GPa, in which a proportion of coarse particles having a particle diameter of 20 μm or more is 20% by mass or less.

A third aspect of the polymer powder according to the present disclosure contains a thermoplastic elastomer having an average particle diameter D50 of 15 μm or less, in which a proportion of coarse particles having a particle diameter of 20 μm or more is 20% by mass or less.

### <First Aspect>

In the first aspect, the preferred aspects of the liquid medium and the polymer are the same as the preferred aspects of the liquid medium and the polymer in the production method of a polymer powder according to the present disclosure.

The polymer swollen in a liquid medium may be only one kind or two or more kinds.

As described above, the pulverized product of the polymer swollen in the liquid medium has a smaller particle diameter than in the related art.

Specifically, the average particle diameter D50 of the polymer powder is preferably 15 μm or less and more preferably 10 μm or less. The lower limit value of the average particle diameter D50 is not particularly limited, and is, for example, 0.01 μm.

In addition, in the polymer particles, the proportion of coarse particles having a particle diameter of 20 μm or more is preferably 20% by mass or less and more preferably 5% by mass or less. The lower limit value of the proportion of the coarse particles is not particularly limited, and the proportion of the coarse particles is particularly preferably 0% by mass.

The average particle diameter D50 and the proportion of coarse particles are measured using a laser diffraction/scattering type particle diameter distribution analyzer. As a laser diffraction/scattering type particle diameter distribution analyzer, for example, LA-950V2 manufactured by Horiba, Ltd. is used.

### <Second Aspect>

In the second aspect, a preferred aspect of the polymer having an elastic modulus of less than 1 GPa is the same as the preferred aspect of the polymer having an elastic modulus of less than 1 GPa in the production method of a polymer powder according to the present disclosure.

The polymer contained in the polymer powder may be only one kind or two or more kinds of polymers having an elastic modulus of less than 1 GPa.

In addition, the polymer powder may contain a polymer other than the polymer having an elastic modulus of less than 1 GPa.

The average particle diameter D50 in the polymer having an elastic modulus of less than 1 GPa is 15 μm or less, and preferably 10 μm or less. The lower limit value of the average particle diameter D50 is not particularly limited, and is, for example, 0.01 μm.

The proportion of coarse particles having a particle diameter of 20 μm or more in the polymer having an elastic modulus of less than 1 GPa is 20% by mass or less, and preferably 5% by mass or less. The lower limit value of the proportion of the coarse particles is not particularly limited, and the proportion of the coarse particles is particularly preferably 0% by mass.

### <Third Aspect>

In the third aspect, the preferred aspect of the thermoplastic elastomer is the same as the preferred aspect of the thermoplastic elastomer in the production method of a polymer powder according to the present disclosure.

The polymer powder may contain only one kind of thermoplastic elastomer or two or more kinds of thermoplastic elastomers.

In addition, the polymer powder may contain a polymer other than the thermoplastic elastomer.

The average particle diameter D50 in the thermoplastic elastomer is 15 μm or less, and preferably 10 μm or less. The lower limit value of the average particle diameter D50 is not particularly limited, and is, for example, 0.01 μm.

The proportion of coarse particles having a particle diameter of 20 μm or more in the thermoplastic elastomer is 20% by mass or less, and preferably 5% by mass or less. The lower limit value of the proportion of the coarse particles is not particularly limited, and the proportion of the coarse particles is particularly preferably 0% by mass.

### [Polymer Composition]

The polymer powder according to the present disclosure can be mixed with other components to form a polymer composition.

The polymer composition according to the present disclosure contains the polymer powder according to the present disclosure.

From the viewpoint of application to a low transmission loss film, the polymer composition according to the present disclosure preferably contains a polymer having a dielectric loss tangent of 0.01 or less.

### (Polymer Having Dielectric Loss Tangent of 0.01 or Less)

The dielectric loss tangent of the polymer having a dielectric loss tangent of 0.01 or less is preferably 0.005 or less, and more preferably more than 0 and 0.003 or less.

In the present disclosure, the dielectric loss tangent is measured by the following method.

The dielectric loss tangent is measured by a resonance perturbation method at a frequency of 10 GHz. A 10 GHz cavity resonator (“CP531” manufactured by Kanto Electronic Application & Development Inc.) is connected to a network analyzer (“E8363B” manufactured by Agilent Technologies, Inc.), a measurement sample is inserted into the cavity resonator, and the measurement is performed from the change in resonance frequency before and after the insertion for 96 hours in an environment of a temperature of 25° C. and a humidity of 60% RH.

Examples of the polymer having a dielectric loss tangent of 0.01 or less include thermoplastic resins such as a liquid crystal polymer, a fluororesin, a polymerized substance of a compound which has a cyclic aliphatic hydrocarbon group and a group having an ethylenically unsaturated bond, polyether ether ketone, polyolefin, polyamide, polyester, polyphenylene sulfide, polyether ketone, polycarbonate, polyethersulfone, polyphenylene ether and a modified product thereof, and polyetherimide; elastomers such as a copolymer of glycidyl methacrylate and polyethylene; and thermosetting resins such as a phenol resin, an epoxy resin, a polyimide, and a cyanate resin.

### —Liquid Crystal Polymer—

From the viewpoint of dielectric loss tangent, the polymer having a dielectric loss tangent of 0.01 or less is preferably a liquid crystal polymer. That is, the polymer composition preferably contains a liquid crystal polymer.

The kind of the liquid crystal polymer is not particularly limited, and a known liquid crystal polymer can be used.

In addition, the liquid crystal polymer may be a thermotropic liquid crystal polymer which exhibits liquid crystallinity in a molten state, or may be a lyotropic liquid crystal polymer which exhibits liquid crystallinity in a solution state. In addition, in a case of the thermotropic liquid crystal, it is preferable that the liquid crystal is melted at a temperature of 450° C. or lower.

Examples of the liquid crystal polymer include a liquid crystal polyester, a liquid crystal polyester amide in which an amide bond is introduced into the liquid crystal polyester, a liquid crystal polyester ether in which an ether bond is introduced into the liquid crystal polyester, and a liquid crystal polyester carbonate in which a carbonate bond is introduced into the liquid crystal polyester.

In addition, as the liquid crystal polymer, from the viewpoint of liquid crystallinity, a polymer having an aromatic ring is preferable, and an aromatic polyester or an aromatic polyester amide is more preferable.

Furthermore, the liquid crystal polymer may be a polymer in which an imide bond, a carbodiimide bond, a bond derived from an isocyanate, such as an isocyanurate bond, or the like is further introduced into the aromatic polyester or the aromatic polyester amide.

In addition, it is preferable that the liquid crystal polymer is a fully aromatic liquid crystal polymer formed of only an aromatic compound as a raw material monomer.

Examples of the liquid crystal polymer include the following liquid crystal polymers.
1) a liquid crystal polymer obtained by polycondensing (i) an aromatic hydroxycarboxylic acid, (ii) an aromatic dicarboxylic acid, and (iii) at least one compound selected from the group consisting of an aromatic diol, an aromatic hydroxyamine, and an aromatic diamine.
2) a liquid crystal polymer obtained by polycondensing a plurality of kinds of aromatic hydroxycarboxylic acids.
3) a liquid crystal polymer obtained by polycondensing (i) an aromatic dicarboxylic acid and (ii) at least one compound selected from the group consisting of an aromatic diol, an aromatic hydroxyamine, and an aromatic diamine.
4) a liquid crystal polymer obtained by polycondensing (i) polyester such as polyethylene terephthalate and (ii) an aromatic hydroxycarboxylic acid.

Here, the aromatic hydroxycarboxylic acid, the aromatic dicarboxylic acid, the aromatic diol, the aromatic hydroxyamine, and the aromatic diamine may be each independently replaced with a polycondensable derivative.

A melting point of the liquid crystal polymer is preferably equal to or higher than 250° C., more preferably from 250° C. to 350° C., and still more preferably from 260° C. to 330° C.

In the present disclosure, the melting point is measured using a differential scanning calorimetry apparatus. For example, the measurement is performed using product name “DSC-60A Plus” (manufactured by Shimadzu Corporation). A temperature rising rate in the measurement is set to 10° C./minute.

The weight-average molecular weight of the liquid crystal polymer is preferably 1,000,000 or less, more preferably from 3,000 to 300,000, still more preferably from 5,000 to 100,000, and particularly preferably from 5,000 to 30,000.

The liquid crystal polymer preferably contains an aromatic polyester amide from a viewpoint of further decreasing the dielectric loss tangent. The aromatic polyester amide is a resin having at least one aromatic ring and having an ester bond and an amide bond. Among these, from the viewpoint of heat resistance, the aromatic polyester amide is preferably a fully aromatic polyester amide.

The aromatic polyester amide is preferably a crystalline polymer. The polymer composition preferably contains a crystalline aromatic polyester amide. In a case where the aromatic polyester amide is crystalline, the dielectric loss tangent is further reduced.

The crystalline polymer refers to a polymer having a clear endothermic peak, not a stepwise endothermic amount changed, in differential scanning calorimetry (DSC). Specifically, for example, this means that a half-width of an endothermic peak in measuring at a temperature rising rate 10° C./minute is within 10° C. A polymer in which a half-width exceeds 10° C. and a polymer in which a clear endothermic peak is not recognized are distinguished as an amorphous polymer from a crystalline polymer.

Aromatic polyester amide preferably contains a constitutional unit represented by Formula 1, a constitutional unit represented by Formula 2, and a constitutional unit represented by Formula 3.

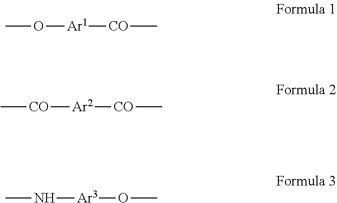

In Formula 1 to Formula 3, Ar¹, Ar², and Ar³ each independently represent a phenylene group, a naphthylene group, or a biphenylylene group.

Hereinafter, the constitutional unit represented by Formula 1 and the like are also referred to as “unit 1” and the like.

The unit 1 can be introduced, for example, using aromatic hydroxycarboxylic acid as a raw material.

The unit 2 can be introduced, for example, using aromatic dicarboxylic acid as a raw material.

The unit 3 can be introduced, for example, using aromatic hydroxylamine as a raw material.

Here, the aromatic hydroxycarboxylic acid, the aromatic dicarboxylic acid, the aromatic diol, and the aromatic hydroxylamine may be each independently replaced with a polycondensable derivative.

For example, the aromatic hydroxycarboxylic acid and the aromatic dicarboxylic acid can be replaced with aromatic hydroxycarboxylic acid ester and aromatic dicarboxylic acid ester, by converting a carboxy group into an alkoxycarbonyl group or an aryloxycarbonyl group.

The aromatic hydroxycarboxylic acid and the aromatic dicarboxylic acid can be replaced with aromatic hydroxycarboxylic acid halide and aromatic dicarboxylic acid halide, by converting a carboxy group into a haloformyl group.

The aromatic hydroxycarboxylic acid and the aromatic dicarboxylic acid can be replaced with aromatic hydroxycarboxylic acid anhydride and aromatic dicarboxylic acid anhydride, by converting a carboxy group into an acyloxycarbonyl group.

Examples of a polymerizable derivative of a compound having a hydroxy group, such as an aromatic hydroxycarboxylic acid and an aromatic hydroxyamine, include a derivative (acylated product) obtained by acylating a hydroxy group and converting the acylated group into an acyloxy group.

For example, the aromatic hydroxycarboxylic acid and the aromatic hydroxylamine can be each replaced with an acylated product by acylating a hydroxy group and converting the acylated group into an acyloxy group.

Examples of a polycondensable derivative of the aromatic hydroxylamine include a substance (acylated product) obtained by acylating an amino group to convert the amino group into an acylamino group.

For example, the aromatic hydroxyamine can be replaced with an acylated product by acylating an amino group and converting the acylated group into an acylamino group.

In Formula 1, Ar¹ is preferably a p-phenylene group, a 2,6-naphthylene group, or a 4,4′-biphenylylene group, and more preferably a 2,6-naphthylene group.

In a case where Ar¹ is a p-phenylene group, the unit 1 is, for example, a constitutional unit derived from p-hydroxybenzoic acid.

In a case where Ar¹ is a 2,6-naphthylene group, the unit 1 is, for example, a constitutional unit derived from 6-hydroxy-2-naphthoic acid.

In a case where Ar¹ is a 4,4′-biphenylylene group, the unit 1 is, for example, a constitutional unit derived from 4′-hydroxy-4-biphenylcarboxylic acid.

In Formula 2, Ar² is preferably a p-phenylene group, an m-phenylene group, or a 2,6-naphthylene group, and more preferably an m-phenylene group.

In a case where Ar² is a p-phenylene group, the unit 2 is, for example, a constitutional unit derived from terephthalic acid.

In a case where Ar² is an m-phenylene group, the unit 2 is, for example, a constitutional unit derived from isophthalic acid.

In a case where Ar² is a 2,6-naphthylene group, the unit 2 is, for example, a constitutional unit derived from 2,6-naphthalenedicarboxylic acid.

In Formula 3, Ar³ is preferably a p-phenylene group or a 4,4′-biphenylylene group, and more preferably a p-phenylene group.

In a case where Ar³ is a p-phenylene group, the unit 3 is, for example, a constitutional unit derived from p-aminophenol.

In a case where Ar³ is a 4,4′-biphenylylene group, the unit 3 is, for example, a constitutional unit derived from 4-amino-4′-hydroxybiphenyl.

With respect to the total content of the unit 1, the unit 2, and the unit 3, a content of the unit 1 is preferably 30 mol % or more, a content of the unit 2 is preferably 35% or less, and a content of the unit 3 is preferably 35 mol % or less.

The content of the unit 1 is preferably from 30 mol % to 80 mol %, more preferably from 30 mol % to 60 mol %, and particularly preferably from 30 mol % to 40 mol % with respect to the total content of the unit 1, the unit 2, and the unit 3.

The content of the unit 2 is preferably from 10 mol % to 35 mol %, more preferably from 20 mol % to 35 mol %, and particularly preferably from 30 mol % to 35 mol % with respect to the total content of the unit 1, the unit 2, and the unit 3.

The content of the unit 3 is preferably from 10 mol % to 35 mol %, more preferably from 20 mol % to 35 mol %, and particularly preferably from 30 mol % to 35 mol % with respect to the total content of the unit 1, the unit 2, and the unit 3.

The total content of the constitutional units is a value obtained by totaling a substance amount (mol) of each constitutional unit. The substance amount of each constitutional unit is calculated by dividing a mass of each constitutional unit constituting aromatic polyester amide by a formula weight of each constitutional unit.

In a case where a ratio of the content of the unit 2 to the content of the unit 3 is expressed as [Content of unit 2]/[Content of unit 3] (mol/mol), the ratio is preferably from 0.9/1 to 1/0.9, more preferably from 0.95/1 to 1/0.95, and still more preferably from 0.98/1 to 1/0.98.

Aromatic polyester amide may have two kinds or more of the unit 1 to the unit 3 each independently. Alternatively, aromatic polyester amide may have other constitutional units other than the unit 1 to the unit 3. A content of other constitutional units is preferably 10% by mole or less and more preferably 5% by mole or less with respect to the total content of all constitutional units.

Aromatic polyester amide is preferably produced by subjecting a raw material monomer corresponding to the constitutional unit constituting the aromatic polyester amide to melt polymerization.

The weight-average molecular weight of aromatic polyester amide is preferably 1,000,000 or less, more preferably from 3,000 to 300,000, still more preferably from 5,000 to 100,000, and particularly preferably from 5,000 to 30,000.

### —Fluororesin—

From the viewpoint of heat resistance and mechanical strength, the polymer having a dielectric loss tangent of 0.01 or less may be a fluororesin.

In the present disclosure, the kind of the fluororesin is not particularly limited, and a known fluororesin can be used.

Examples of the fluororesin include a homopolymer and a copolymer containing a constitutional unit derived from a fluorinated α-olefin monomer, that is, an α-olefin monomer containing at least one fluorine atom. In addition, examples of the fluororesin include a copolymer containing a constitutional unit derived from a fluorinated α-olefin monomer, and a constitutional unit derived from a non-fluorinated ethylenically unsaturated monomer reactive to the fluorinated α-olefin monomer.

Examples of the fluorinated α-olefin monomer include CF₂═CF₂, CHF═CF₂, CH₂═CF₂, CHCl═CHF, CClF═CF₂, CCl₂═CF₂, CClF═CClF, CHF═CCl₂, CH₂═CClF, CCl₂═CClF, CF₃CF═CF₂, CF₃CF═CHF, CF₃CH═CF₂, CF₃CH═CH₂, CHF₂CH═CHF, CF₃CF═CF₂, and perfluoro (alkyl having 2 to 8 carbon atoms) vinyl ether (for example, perfluoromethyl vinyl ether, perfluoropropyl vinyl ether, and perfluorooctyl vinyl ether). Among these, as the fluorinated α-olefin monomer, at least one monomer selected from the group consisting of tetrafluoroethylene (CF₂═CF₂), chlorotrifluoroethylene (CClF═CF₂), (perfluorobutyl)ethylene, vinylidene fluoride (CH₂═CF₂), and hexafluoropropylene (CF₂═CFCF₃) is preferable.

Examples of the non-fluorinated ethylenically unsaturated monomer include ethylene, propylene, butene, and an ethylenically unsaturated aromatic monomer (for example, styrene and α-methylstyrene).

The fluorinated α-olefin monomer may be used alone or in combination of two or more thereof.

In addition, the non-fluorinated ethylenically unsaturated monomer may be used alone or in combination of two or more thereof.

Examples of the fluororesin include polychlorotrifluoroethylene (PCTFE), poly(chlorotrifluoroethylene-propylene), poly(ethylene-tetrafluoroethylene) (ETFE), (ECTFE), poly(ethylene-chlorotrifluoroethylene) poly(hexafluoropropylene), poly(tetrafluoroethylene-ethylene-propylene), poly(tetrafluoroethylene) (PTFE), poly(tetrafluoroethylene-hexafluoropropylene) (FEP), poly(tetrafluoroethylene-propylene) (FEPM), poly(tetrafluoroethylene-perfluoropropylene vinyl ether), poly(tetrafluoroethylene-perfluoroalkyl vinyl ether) (PFA) (for example, poly(tetrafluoroethylene-perfluoropropyl vinyl ether)), polyvinyl fluoride (PVF), polyvinylidene fluoride (PVDF), poly(vinylidene fluoride-chlorotrifluoroethylene), perfluoropolyether, perfluorosulfonic acid, and perfluoropolyoxetane.

The fluororesin may have a constitutional unit derived from fluorinated ethylene or fluorinated propylene.

The fluororesin may be used alone or in combination of two or more thereof.

The fluororesin is preferably FEP, PFA, ETFE, or PTFE.

The FEP is available from Du Pont as the trade name of TEFLON (registered trademark) FEP or from DAIKIN INDUSTRIES, LTD. as the trade name of NEOFLON FEP. The PFA is available from DAIKIN INDUSTRIES, LTD. as the trade name of NEOFLON PFA, from Du Pont as the trade name of TEFLON (registered trademark) PFA, or from Solvay Solexis as the trade name of HYFLON PFA.

The fluororesin more preferably includes PTFE. The PTFE may be a PTFE homopolymer, a partially modified PTFE homopolymer, or a combination including one or both of these. The partially modified PTFE homopolymer preferably contains a constitutional unit derived from a comonomer other than tetrafluoroethylene in an amount of less than 1% by mass based on the total mass of the polymer.

The fluororesin may be a crosslinkable fluoropolymer having a crosslinkable group. The crosslinkable fluoropolymer can be crosslinked by a known crosslinking method in the related art. One of the representative crosslinkable fluoropolymers is a fluoropolymer having (meth)acryloyloxy. For example, the crosslinkable fluoropolymer can be represented by the following formula.

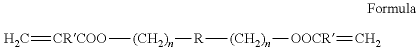

In the formula, R is an oligomer chain having a constitutional unit derived from the fluorinated α-olefin monomer, R′ is H or —CH₃, and n is from 1 to 4. R may be a fluorine-based oligomer chain having a constitutional unit derived from tetrafluoroethylene.

In order to initiate a radical crosslinking reaction through the (meth)acryloyloxy group in the fluororesin, by exposing the fluoropolymer having a (meth)acryloyloxy group to a free radical source, a crosslinked fluoropolymer network can be formed. The free radical source is not particularly limited, and suitable examples thereof include a photoradical polymerization initiator and an organic peroxide. Appropriate photoradical polymerization initiators and organic peroxides are well known in the art. The crosslinkable fluoropolymer is commercially available, and examples thereof include Viton B manufactured by Du Pont.

—Polymerized Substance of Compound which has Cyclic Aliphatic Hydrocarbon Group and Group Having Ethylenically Unsaturated Bond—

The polymer having a dielectric loss tangent of 0.01 or less may be a polymerized substance of a compound which has a cyclic aliphatic hydrocarbon group and a group having an ethylenically unsaturated bond.

Examples of the polymerized substance of a compound which has a cyclic aliphatic hydrocarbon group and a group having an ethylenically unsaturated bond include thermoplastic resins having a constitutional unit derived from a cyclic olefin monomer such as norbornene and a polycyclic norbornene-based monomer.

The polymerized substance of a compound which has a cyclic aliphatic hydrocarbon group and a group having an ethylenically unsaturated bond may be a ring-opened polymer of the above-described cyclic olefin, a hydrogenated product of a ring-opened copolymer using two or more cyclic olefins, or an addition polymer of a cyclic olefin and a linear olefin or aromatic compound having an ethylenically unsaturated bond such as a vinyl group. In addition, a polar group may be introduced into the polymerized substance of a compound which has a cyclic aliphatic hydrocarbon group and a group having an ethylenically unsaturated bond.

The polymerized substance of a compound which has a cyclic aliphatic hydrocarbon group and a group having an ethylenically unsaturated bond may be used alone or in combination of two or more thereof.

A ring structure of the cyclic aliphatic hydrocarbon group may be a single ring, a fused ring in which two or more rings are fused, or a crosslinked ring.

Examples of the ring structure of the cyclic aliphatic hydrocarbon group include a cyclopentane ring, a cyclohexane ring, a cyclooctane ring, an isophorone ring, a norbornane ring, and a dicyclopentane ring.

The compound which has a cyclic aliphatic hydrocarbon group and a group having an ethylenically unsaturated bond is not particularly limited, and examples thereof include a (meth)acrylate compound having a cyclic aliphatic hydrocarbon group, a (meth)acrylamide compound having a cyclic aliphatic hydrocarbon group, and a vinyl compound having a cyclic aliphatic hydrocarbon group. Among these, preferred examples thereof include a (meth)acrylate compound having a cyclic aliphatic hydrocarbon group. In addition, the compound which has a cyclic aliphatic hydrocarbon group and a group having an ethylenically unsaturated bond may be a monofunctional ethylenically unsaturated compound or a polyfunctional ethylenically unsaturated compound.

The number of cyclic aliphatic hydrocarbon groups in the compound which has a cyclic aliphatic hydrocarbon group and a group having an ethylenically unsaturated bond may be 1 or more, and may be 2 or more.

The polymerized substance of a compound having a cyclic aliphatic hydrocarbon group and a group having an ethylenically unsaturated bond may be a polymer obtained by polymerizing at least one kind of a cyclic aliphatic hydrocarbon group and a compound having a group having an ethylenically unsaturated bond, may be a polymerized substance of a compound having two or more kinds of cyclic aliphatic hydrocarbon groups and an ethylenically unsaturated bond, and may be a copolymer with another ethylenically unsaturated compound having no cyclic aliphatic hydrocarbon group.

In addition, the polymerized substance of a compound which has a cyclic aliphatic hydrocarbon group and a group having an ethylenically unsaturated bond is preferably a cycloolefin polymer.

### —Polyphenylene Ether—

The polymer having a dielectric loss tangent of 0.01 or less may be a polyphenylene ether.

In the polyphenylene ether, from the viewpoint of dielectric loss tangent and heat resistance, the average number of molecular terminal phenolic hydroxyl groups per molecule (the number of terminal hydroxyl groups) is preferably from 1 to 5 and more preferably from 1.5 to 3.

The number of terminal hydroxyl groups in the polyphenylene ether can be found, for example, from a standard value of a product of the polyphenylene ether. In addition, the number of terminal hydroxyl groups is expressed as, for example, an average value of the number of phenolic hydroxyl groups per molecule of all polyphenylene ethers present in 1 mol of the polyphenylene ether.

The polyphenylene ether may be used alone or in combination of two or more thereof.

Examples of the polyphenylene ether include a polyphenylene ether including 2,6-dimethylphenol and at least one of bifunctional phenol or trifunctional phenol, and poly(2,6-dimethyl-1,4-phenylene oxide). More specifically, the polyphenylene ether is preferably a compound having a structure represented by Formula (PPE).

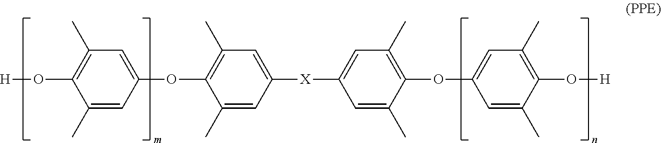

In Formula (PPE), X represents an alkylene group having 1 to 3 carbon atoms or a single bond, m represents an integer of 0 to 20, n represents an integer of 0 to 20, and the sum of m and n represents an integer of 1 to 30.

Examples of the alkylene group in X described above include a dimethylmethylene group.

In a case where heat curing is performed after film formation, from the viewpoint of heat resistance and film-forming property, a weight-average molecular weight (Mw) of the polyphenylene ether is preferably from 500 to 5,000 and preferably from 500 to 3,000. In addition, in a case where the heat curing is not performed, the weight-average molecular weight (Mw) of the polyphenylene ether is not particularly limited, but is preferably from 3,000 to 100,000 and preferably from 5,000 to 50,000.

### —Aromatic Polyether Ketone—

The polymer having a dielectric loss tangent of 0.01 or less may be an aromatic polyether ketone.

The aromatic polyether ketone is not particularly limited, and a known aromatic polyether ketone can be used.

The aromatic polyether ketone is preferably a polyether ether ketone.

The polyether ether ketone is one kind of the aromatic polyether ketone, and is a polymer in which bonds are arranged in the order of an ether bond, an ether bond, and a carbonyl bond. It is preferable that the bonds are linked to each other by a divalent aromatic group.

The aromatic polyether ketone may be used alone or in combination of two or more thereof.

Examples of the aromatic polyether ketone include polyether ether ketone (PEEK) having a chemical structure represented by Formula (P1), polyether ketone (PEK) having a chemical structure represented by Formula (P2), polyether ketone ketone (PEKK) having a chemical structure represented by Formula (P3), polyether ether ketone ketone (PEEKK) having a chemical structure represented by Formula (P4), and polyether ketone ether ketone ketone (PEKEKK) having a chemical structure represented by Formula (P5).

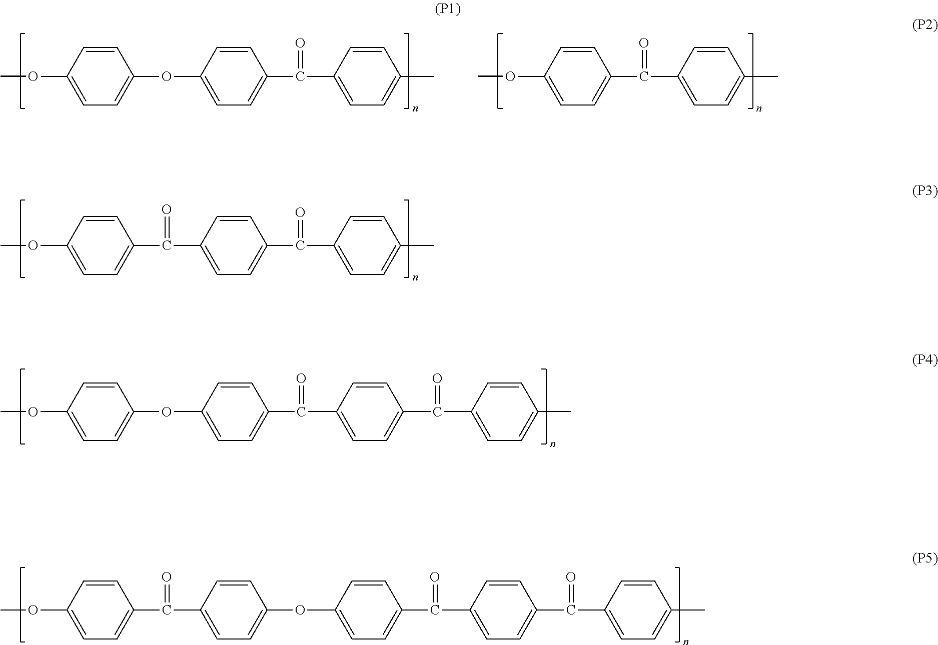

From the viewpoint of mechanical properties, each n of Formulae (P1) to (P5) is preferably 10 or more and more preferably 20 or more. On the other hand, from the viewpoint that the aromatic polyether ketone can be easily produced, n is preferably 5,000 or less and more preferably 1,000 or less. That is, n is preferably from 10 to 5,000 and more preferably from 20 to 1,000.

The content of the polymer having a dielectric loss tangent of 0.01 or less is preferably 0.1% by mass to 90% by mass, more preferably 1% by mass to 40% by mass, and still more preferably 3% by mass to 20% by mass with respect to the total mass of the polymer composition.

The content of the polymer having a dielectric loss tangent of 0.01 or less is preferably 1% by mass to 100% by mass, more preferably 5% by mass to 50% by mass, and still more preferably 10% by mass to 30% by mass with respect to the total solid content of the polymer composition.

The polymer composition according to the present disclosure may contain other additives in addition to the polymer powder and the polymer having a dielectric loss tangent of 0.01.

Known additives can be used as other additives. Examples of other additives include a curing agent, a leveling agent, an antifoaming agent, an antioxidant, an ultraviolet absorber, a flame retardant, and a colorant.

### [Polymer Film]

The polymer film according to the present disclosure contains the polymer powder according to the present disclosure.

From the viewpoint of application to a low transmission loss film, the polymer film according to the present disclosure preferably contains a polymer having a dielectric loss tangent of 0.01 or less.

The preferred aspect of the polymer having a dielectric loss tangent of 0.01 or less is the same as the preferred aspect of the polymer having a dielectric loss tangent of 0.01 or less, which may be contained in the polymer composition according to the present disclosure.

The polymer film according to the present disclosure is homogeneous because it contains a polymer powder having a smaller particle diameter and fewer coarse particles than those of the polymer powder in the related art.

The polymer film according to the present disclosure may contain other additives in addition to the polymer powder and the polymer having a dielectric loss tangent of 0.01.

Examples of the other additives include the same additives as those which may be included in the polymer composition according to the present disclosure.

The average thickness of the polymer film according to the present disclosure is not particularly limited, but from the viewpoint of dielectric loss tangent and step followability, the average thickness is preferably from 5 μm to 90 μm, more preferably from 10 μm to 70 μm, and particularly preferably from 15 μm to 50 μm.

The average thickness of the polymer film is measured at optional five sites using an adhesive film thickness meter, for example, an electronic micrometer (product name “KG3001A”, manufactured by Anritsu Corporation), and the average value of the measured values is defined as the average thickness of the polymer film.

### EXAMPLES

Hereinafter, the present disclosure will be described in more detail with reference to Examples. The materials, the used amounts, the proportions, the treatment contents, the treatment procedures, and the like described in the following examples can be appropriately changed without departing from the gist of the present disclosure. Therefore, the scope of the present disclosure is not limited to the following specific examples.

### Examples 1 to 5 and Comparative Examples 1 to 4

### [Production of Polymer Powder]

### —Preparation of Polymer—

P1: hydrogenated styrene-isobutylene-styrene block copolymer (product name “SIBSTAR 103T-UL”, manufactured by Kaneka Corporation), weight-average molecular weight: 100,000

P2: hydrogenated styrene-ethylene/butylene-styrene block copolymer (product name “TUFTEC M1913”, manufactured by Asahi Kasei Corporation), weight-average molecular weight: 140,000

The storage elastic moduli of both the polymer P1 and the polymer P2 were less than 0.1 GPa.

### —Swelling Step—

The pellets of the polymers shown in Table 1 and the liquid medium shown in Table 1 were placed in a container at a mass ratio of 1:2 and held at 25° C. to produce swollen pellets. The swelling ratio was adjusted by the retention time. For example, in Example 1 (swelling ratio of 150%), the retention time was 72 hours, and in Comparative Examples 1 and 3 (both swelling ratios of 0%), the polymer was immersed in the liquid medium, but the polymer was not swollen in the liquid medium without providing the retention time. In addition, in Comparative Examples 2 and 4, the swelling step was not performed.

### (Swelling Ratio)

After swelling the polymer in a liquid medium, about 1 g of a measurement sample was collected from the swollen polymer, and the measurement sample was weighed. The mass measured by weighing was denoted by W1 (g). The measurement sample was dried for 3 hours, and the dried measurement sample was weighed. The mass after weighing was denoted as W0 (g). The swelling degree was calculated according to the following expression. The drying temperature in a case of drying the measurement sample was set to a higher temperature between a boiling point of the liquid medium used for swelling the polymer and a glass transition temperature of the polymer.

$$Swelling degree ( \% ) = \{ ( W 1 - W 0 ) / W 0 \} \times 100$$

### —Pulverizing Step—

A pulverization treatment was performed using any of the pulverization methods (pulverization A, pulverization B, or pulverization C) described in Table 1 to obtain a polymer powder. In Examples 1 to 5, the composition containing the swollen pellet and the liquid medium, which were obtained in the swelling step, was used as a pulverization target. In Comparative Examples 1 and 3, the composition including the polymer and the liquid medium shown in Table 1 was used as the object to be pulverized. In Comparative Examples 2 and 4, the polymer shown in Table 1 was used as the object to be pulverized.

### <Pulverization A>

The pulverization target was cooled with liquid nitrogen (in a temperature environment of −196° C.) and frozen. The mixture was put into a low-temperature/freezing pulverization beads mill (LNM type, manufactured by AIMEX Co., Ltd.) and subjected to a pulverization treatment. After the pulverization treatment, the temperature was returned to room temperature again to obtain a composition containing a polymer powder.

### <Pulverization B>

The pulverization target substance was put into an explosion-proof beads mill (BSG type, manufactured by AIMEX Co., Ltd.) without cooling and subjected to a pulverization treatment to obtain a composition containing a polymer powder.

### <Pulverization C>

A pulverization target was placed in a sample room of a ball mill (model “JFC-5000”, manufactured by Japan Analytical Industry Co., Ltd.), cooled with liquid nitrogen (in a temperature environment of −196° C.), and then subjected to a pulverization treatment. After the pulverization treatment, the temperature was returned to room temperature again to obtain a composition containing a polymer powder.

For the obtained polymer powder, a volume-based average particle diameter D50 and a volume-based average particle diameter D90 were measured using a laser diffraction/scattering-type particle diameter distribution analyzer (product name “LA-950V2”, manufactured by Horiba, Ltd.). In addition, the proportion of coarse particles having a particle diameter of 20 μm or more was measured. Coarse particles that could not be evaluated with the measuring device were removed by filtration in advance and added to the proportion of coarse particles having a particle diameter of 20 μm or more. In Comparative Example 2, the polymer powder could not be obtained by the pulverization treatment, and the particle diameter could not be measured.

Table 1 shows the measurement results. In Table 1, NMP means N-methylpyrrolidone. “NMP/methanol=6/4” means a mixed solvent having a mass ratio of NMP to methanol of 6:4.

TABLE 1

| | | | | | Particle diameter of | | |
|---|---|---|---|---|---|---|---|
| | Swelling step | | | Pulverizing | polymer powder | | |
| | | | Swelling | step | | | Proportion |
| | | Liquid | ratio | Pulverizing | D50 | D90 | of 20 μm |
| | Polymer | medium | [%] | method | [μm] | [μm] | or more [%] |
| Example 1 | P1 | NMP | 150 | A | 5 | 8 | 0 |
| Example 2 | P1 | NMP | 50 | A | 9 | 14 | 5 |
| Example 3 | P1 | NMP | 150 | B | 8 | 10 | 1 |
| Example 4 | P2 | NMP | 150 | A | 5 | 8 | 0 |
| Example 5 | P2 | NMP | 150 | B | 6 | 9 | 1 |
| Comparative | P1 | NMP | 0 | A | 14 | 30 | 30 |
| Example 1 | | | | | | | |
| Comparative | P1 | — | 0 | B | — | — | — |
| Example 2 | | | | | | | |
| Comparative | P1 | NMP/methanol = | 0 | A | 20 | 40 | 20 |
| Example 3 | | 6/4 | | | | | |
| Comparative | P2 | — | 0 | C | 5 | 13 | 30 |
| Example 4 | | | | | | | |

As shown in Table 1, it was found that, since Examples 1 to 5 include a step of swelling a polymer having a weight-average molecular weight of 1,000 or more in a liquid medium and a step of pulverizing the swollen polymer to obtain a polymer powder, a polymer powder having a small particle diameter and a small amount of coarse particles is obtained.

On the other hand, in Comparative Examples 1 and 3, since the polymer was only immersed in the liquid medium and the polymer was not swollen in the liquid medium, the particle diameter of the polymer powder was large.

In Comparative Example 2, since the polymer was not swollen in the liquid medium, the polymer powder could not be obtained.

In Comparative Example 4, since the polymer was not swollen in the liquid medium, the polymer powder contained many coarse particles.

### <Production of Polymer Film>

### —Synthesis of Aromatic Polyester Amide P-3—

940.9 g (5.0 mol) of 6-hydroxy-2-naphthoic acid, 415.3 g (2.5 mol) of isophthalic acid, 377.9 g (2.5 mol) of acetaminophen, 867.8 g (8.4 mol) of acetic anhydride are put in a reactor comprising a stirring device, a torque meter, a nitrogen gas introduction pipe, a thermometer, and a reflux condenser, gas in the reactor is substituted with nitrogen gas, a temperature is raised from a room temperature (23° C., the same applies hereinafter) to 140° C. over 60 minutes while stirring under a nitrogen gas flow, and refluxing is performed at 140° C. for three hours.

Next, the temperature was raised from 150° C. to 300° C. over 5 hours while distilling off by-produced acetic acid and unreacted acetic anhydride, and maintained at 300° C. for 30 minutes. Thereafter, a content is taken out from the reactor and is cooled to the room temperature. The obtained solid matter was pulverized with a pulverizer to obtain powdery aromatic polyester amide (flow start temperature: 193° C.).

A solid phase polymerization of the aromatic polyester amide was carried out by heating from room temperature to 160° C. over 2 hours and 20 minutes in a nitrogen atmosphere, further heating from 160° C. to 180° C. over 3 hours and 20 minutes, and holding at 180° C. for 5 hours, and then the resultant was cooled. Next, the mixture was pulverized with a pulverizer to obtain powdery aromatic polyester amide (flow start temperature: 220° C.).

A solid phase polymerization of the aromatic polyester amide was carried out by heating from room temperature to 180° C. over 1 hour and 25 minutes in a nitrogen atmosphere, further heating from 180° C. to 255° C. over 6 hours and 40 minutes, and holding at 255° C. for 5 hours to carry out solid phase polymerization, and then the resultant was cooled to obtain a powdery aromatic polyester amide P3 (melting point: 311° C., dielectric loss tangent: 0.003).

### —Preparation of Polymer Composition—

The aromatic polyester amide P3 and the composition containing the polymer powder produced in Example 1 were mixed so that the mass ratio of the aromatic polyester amide P3 to the polymer powder was 2:8, N-methylpyrrolidone was further added so that the concentration of solid contents was 20% by mass, and the mixture was stirred at 140° C. for 4 hours in a nitrogen atmosphere, thereby obtaining a polymer composition.

### —Preparation of Polymer Film—

The obtained polymer composition was fed to a slot die coater, and applied onto a treated surface of a copper foil (product name “CF-T49A-DS-HD2”, average thickness: 12 μm, manufactured by Fukuda Metal Foil & Powder Co., Ltd.) so that the film thickness was 20 μm, by adjusting the flow rate. The solvent was removed from the coating film by drying at 40° C. for 4 hours. Further, the temperature was raised from room temperature (25° C.) to 300° C. at 1° C./min in a nitrogen atmosphere. A heat treatment of holding the film at 300° C. for 2 hours was carried out to obtain a polymer film having a copper layer.

The appearance of the obtained polymer film was homogeneous without defects.

In addition, a polymer film having a copper layer was obtained by the same method as the production method of the polymer film, except that the composition containing the polymer powder produced in Example 1 was changed to the composition containing the polymer powder produced in Comparative Example 1.

The appearance of the obtained polymer film was non-uniform due to defects such as streaks and leakages.

The disclosure of Japanese Patent Application No. 2023-001988 filed on Jan. 10, 2023 is incorporated in the present specification by reference. In addition, all documents, patent applications, and technical standards described in the present specification are herein incorporated by reference to the same extent that each individual document, patent application, or technical standard was specifically and individually indicated to be incorporated by reference.

What is claimed is:

1. A production method of a polymer powder, comprising:
swelling a polymer having a weight-average molecular weight of 1,000 or more in a liquid medium; and
pulverizing the swollen polymer to obtain a polymer powder.

2. The production method of a polymer powder according to claim 1,
wherein the polymer having a weight-average molecular weight of 1,000 or more has a storage elastic modulus of less than 1 GPa.

3. The production method of a polymer powder according to claim 1,
wherein the polymer having a weight-average molecular weight of 1,000 or more is a thermoplastic elastomer.

4. The production method of a polymer powder according to claim 3,
wherein the thermoplastic elastomer is an elastomer containing a constitutional unit derived from styrene.

5. The production method of a polymer powder according to claim 3,
wherein the thermoplastic elastomer is at least one selected from the group consisting of a styrene-ethylene-butylene-styrene block copolymer, a styrene-isobutylene-styrene block copolymer, a styrene-ethylene-propylene-styrene copolymer, a styrene-isoprene-styrene block copolymer, and hydrogenated products thereof.

6. The production method of a polymer powder according to claim 1,
wherein the swollen polymer has a swelling degree of 1% to 1,000%.

7. The production method of a polymer powder according to claim 1,
wherein an absolute value of a difference between a solubility parameter of the liquid medium and a solubility parameter of the polymer having a weight-average molecular weight of 1,000 or more is from 5 MPa^{1/2} to 10 MPa^{1/2}.

8. The production method of a polymer powder according to claim 1,
wherein the swollen polymer is cooled in a temperature environment of −50° C. or lower, and then pulverized.

9. A polymer powder which is a pulverized product of a polymer swollen in a liquid medium.

10. A polymer powder comprising:
a polymer having an average particle diameter D50 of 15 μm or less, a proportion of coarse particles having a particle diameter of 20 μm or more of 20% by mass or less, and a storage elastic modulus of less than 1 GPa.

11. A polymer powder comprising:
a thermoplastic elastomer having an average particle diameter D50 of 15 μm or less and a proportion of coarse particles having a particle diameter of 20 μm or more of 20% by mass or less.

12. A polymer composition comprising:
the polymer powder according to claim 9.

13. The polymer composition according to claim 12, further comprising:
a polymer having a dielectric loss tangent of 0.01 or less.

14. A polymer film comprising:
the polymer powder according to claim 9.
